(19) United States
(12) Patent Application Publication
(10) Pub. No.: US 2006/0281385 A1
(43) Pub. Date: Dec. 14, 2006

(54) Method of fabricating carbon nanotubes using focused ion beam

(75) Inventors: In-yong Song, Gyeonggi-do (KR); Eun-ju Bae, Gyeonggi-do (KR); Ju-hye Ko, Gyeonggi-do (KR); Wan-jun Park, Seoul (KR)

Correspondence Address: BUCHANAN, INGERSOLL & ROONEY PC, POST OFFICE BOX 1404, ALEXANDRIA, VA, 22313-1404, US

(73) Assignee: SAMSUNG ELECTRONICS CO., LTD., Gyeonggi-do (KR)

(21) Appl. No.: 11/189,981

(22) Filed: Jul. 27, 2005

(30) Foreign Application Priority Data
Jan. 21, 2005 (KR) 10-2005-0005813

(51) Int. Cl. H01J 9/04

(52) U.S. Cl. 445/50; 977/742

(57) ABSTRACT

Provided is a method of fabricating carbon nanotubes using a focused ion beam (FIB). The method includes: preparing a substrate; scanning the substrate with the FIB; and growing the carbon nanotubes on the scanned substrate.

### CROSS-REFERENCE TO RELATED PATENT APPLICATIONS

Priority is claimed to Korean Patent Application No. 10-2005-0005813, filed on Jan. 21, 2005, in the Korean Intellectual Property Office, the disclosure of which is incorporated herein in its entirety by reference.

### BACKGROUND OF THE INVENTION

1. Field of the Invention

The present invention relates to a method of fabricating carbon nanotubes, and more particularly to, a method of fabricating carbon nanotubes using a focused ion beam (FIB).

2. Description of the Related Art

Carbon nanotubes have specific structural and electrical properties and are widely used in many devices, for example, backlights for field emission displays (FEDs) and liquid crystal displays (LCDs), nanoelectronic devices, actuators, and batteries, etc.

Conventional methods of fabricating carbon nanotubes include physical methods, such as an arc discharge method and laser vaporization, and chemical methods, such as chemical vapor deposition (CVD).

FIG. 1 is a schematic view of an arc discharge apparatus used in performing a conventional arc discharge method.

Referring to FIG. 1, in order to perform the arc discharge method, a cathode electrode 11 and an anode electrode 13, which are graphite bars, are installed in the apparatus and a voltage is applied between the electrodes 11 and 13, thereby generating a discharge between the electrodes 11 and 13. When the discharge occurs, carbon crusts separated from the graphite bar acting as the anode electrode 13 are attracted and attached to the graphite bar acting as the cathode electrode 11, which is maintained at a low temperature.

FIG. 2 is a schematic view of a laser vaporization apparatus used in performing a conventional laser vaporization method.

Referring to FIG. 2, in order to perform the laser vaporization method, a reaction furnace 27 is maintained at about 1200° C., and then a laser beam 21 is irradiated to a graphite 23 in the reaction furnace 27 to vaporize the graphite 23. The vaporized graphite 23 is adsorbed onto a collector 25 maintained at a low temperature.

FIG. 3 is a schematic view of an apparatus used in performing a conventional plasma enhanced chemical vapor deposition (PECVD) method. In the PECVD method, a reaction gas in a vacuum tube is discharged due to an energy of a radio-frequency (RF) wave electric field or a direct current applied between two electrodes.

Referring to FIG. 3, a substrate 31 on which carbon nanotubes are to be synthesized is disposed on a grounded bottom electrode 32 and a reaction gas is supplied between a top electrode 34 and the bottom electrode 32. A heat resistant heater 33 is disposed below the bottom electrode 32 or filaments 35 are disposed between the top electrode 34 and the bottom electrode 32, to decompose the reaction gas. The energy required to decompose the reaction gas and synthesize the carbon nanotubes is supplied from an RF power supply 37.

In the conventional physical or chemical methods, a processing accuracy is low and a selective patterning on a fine portion of the substrate cannot be easily performed. Thus, the carbon nanotubes cannot be easily selectively grown on the fine portion according to the desired pattern.

### SUMMARY OF THE INVENTION

The present invention provides a method of fabricating carbon nanotubes using a focused ion beam (FIB), in which the carbon nanotubes can be selectively grown at the nano-level on a fine portion of a substrate.

According to an aspect of the present invention, there is provided a method of fabricating carbon nanotubes using an FIB, comprising: preparing a substrate; scanning the substrate with the FIB; and growing the carbon nanotubes on the scanned substrate.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view of an arc discharge apparatus used in performing a conventional arc discharge method;

FIG. 2 is a schematic view of a laser vaporization apparatus used in performing a conventional laser vaporization method;

FIG. 3 is a schematic view of an apparatus used in performing a conventional plasma enhanced chemical vapor deposition (PECVD) method;

FIGS. 4A through 4C are schematic views illustrating a method of fabricating carbon nanotubes using a focused ion beam (FIB) according to an embodiment of the present invention;

FIGS. 5A through 5D are schematic views illustrating a method of fabricating carbon nanotubes using an FIB according to another embodiment of the present invention;

FIG. 6 is a view of carbon nanotubes obtained using a method of fabricating carbon nanotubes using an FIB according to an embodiment of the present invention;

FIG. 7 is an enlarged view of a portion A illustrated in FIG. 6; and

FIG. 8 is a view of a portion of a pattern formed using an FIB.

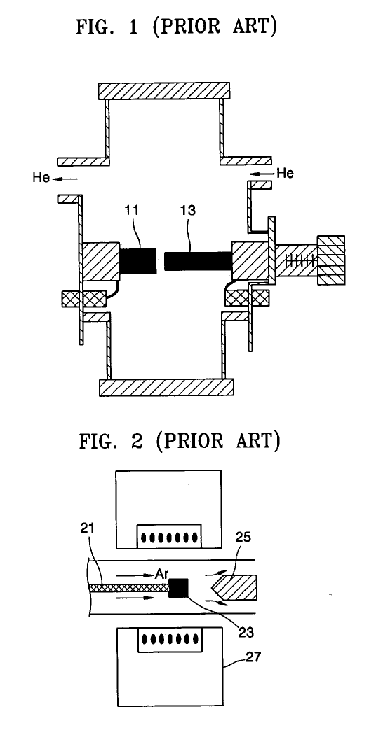

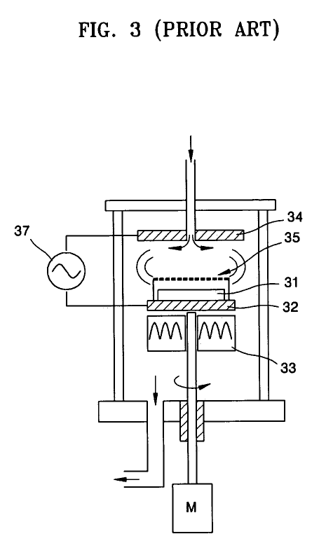

### DETAILED DESCRIPTION OF THE INVENTION

Hereinafter, a method of fabricating carbon nanotubes using a focused ion beam (FIB) according to exemplary embodiments of the present invention will be described in more detail with reference to the attached drawings. Like reference numerals in the drawings denotes like elements.

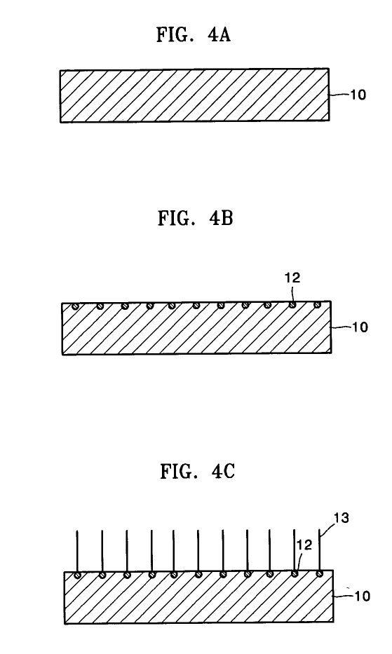

FIGS. 4A through 4C are schematic views illustrating a method of fabricating carbon nanotubes using an FIB according to an embodiment of the present invention.

Referring to FIG. 4A, a substrate 10 is prepared. The substrate 10 may be composed of at least one material selected from the group consisting of Si, SiO₂, Al₂O₃, GaN, GaAs, SiC, and SiN, for example.

Referring to FIG. 4B, a surface of the substrate 10 is scanned with the FIB. Then, ions 12 contained in the FIB are implanted into the surface of the substrate 10. The ions 12 may be gallium (Ga) ions. An FIB apparatus projecting the FIB has a very high capability of decomposing a sample and allows for a nano-level decomposition of the sample. Thus, by scanning the substrate 10 with the FIB, the substrate 10 can be scanned with nano-level accuracy. Further, a predetermined portion of the substrate 10 can be selectively scanned using the high decomposition capability of the FIB apparatus, and thus, various patterns can be easily formed on the substrate 10.

Referring to FIG. 4C, the carbon nanotubes 13 are grown on the scanned substrate 10. At this time, the ions 12 function as growth nuclei for the carbon nanotubes 13 and thus, the carbon nanotubes 13 are vertically grown based on the ions 12. A hydrocarbon gas, such as CH₄, C₂H₂, C₂H₄, and C₂H₆ may be used to grow the carbon nanotubes 13. The carbon nanotubes 13 may be grown using a chemical vapor deposition (CVD) method, for example, a thermal CVD method and a plasma enhanced chemical vapor deposition (PECVD) method. When the carbon nanotubes 13 are grown using the thermal CVD method, a growth uniformity of the carbon nanotubes 13 is very high and the carbon nanotubes 13 can have a smaller diameter than in the PECVD method, and as a result, the carbon nanotubes 13 can have a low turn-on voltage. When the carbon nanotubes 13 are grown using the PECVD method, the carbon nanotubes 13 can be more easily vertically grown on the substrate 10 and synthesized at a lower temperature than in the thermal CVD method. The vertical growth of the carbon nanotubes 13 depends on a direction of the electric field applied between the anode electrode and the cathode electrode in the PECVD system, and thus, the growth direction of the carbon nanotubes 13 can be controlled by the direction of the electric field. Since the growth direction of the carbon nanotubes 13 is constant, a density of growth can be easily controlled and electrons can be easily emitted due to the electric field.

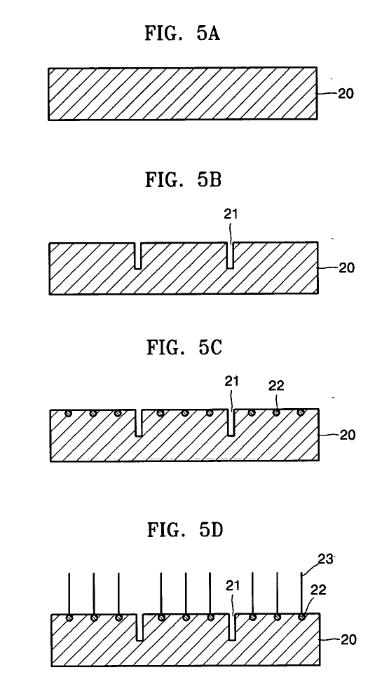

FIGS. 5A through 5D are schematic views illustrating a method of fabricating carbon nanotubes using an FIB according to another embodiment of the present invention.

Referring to FIG. 5A, a substrate 20 is prepared. The substrate 20 may be composed of at least one material selected from the group consisting of Si, SiO₂, Al₂O₃, GaN, GaAs, SiC, and SiN, for example.

Referring to FIG. 5B, the substrate 20 is patterned using the FIB to form a predetermined pattern 21. In this embodiment, the patterning of the substrate 20 is performed using an FIB apparatus having a very high decomposition capability, and thus the substrate 20 can be patterned with nano-level accuracy.

Referring to FIG. 5C, a surface of the substrate 20 is scanned with the FIB. Then, ions 22, for example, Ga ions, contained in the FIB are implanted into the surface of the substrate 20. During this scanning process, the ions 22 may be projected onto a portion of the substrate 20 on which the pattern 21 is not formed, and then implanted onto the portion.

Referring to FIG. 5D, the carbon nanotubes 23 are grown on the scanned substrate 20. At this time, the ions 22 function as growth nuclei for the carbon nanotubes 23 and thus, the carbon nanotubes 23 are vertically grown based on the ions 22. As described above, when the ions 22 are disposed on the portion of the substrate 20 on which the pattern 21 is not formed, the carbon nanotubes 23 are grown on the surface of the portion of the substrate 20 on which the pattern 21 is not formed. That is, the nano-level pattern 21 is formed on the surface of the substrate 20 using the FIB apparatus having a nano-level decomposition capability and thus, the carbon nanotubes 23 may be grown on the substrate 20 according to the pattern 21. Thus, according to the present embodiment, the carbon nanotubes 23 can be selectively grown on the fine portion of the substrate 20 and the pattern 21 can be easily formed in various forms.

A hydrocarbon gas, such as CH₄, C₂H₂, C₂H₄, and C₂H₆ may be used to grow the carbon nanotubes 23. The carbon nanotubes 23 may be grown using a CVD method, for example, a thermal CVD method and a PECVD method.

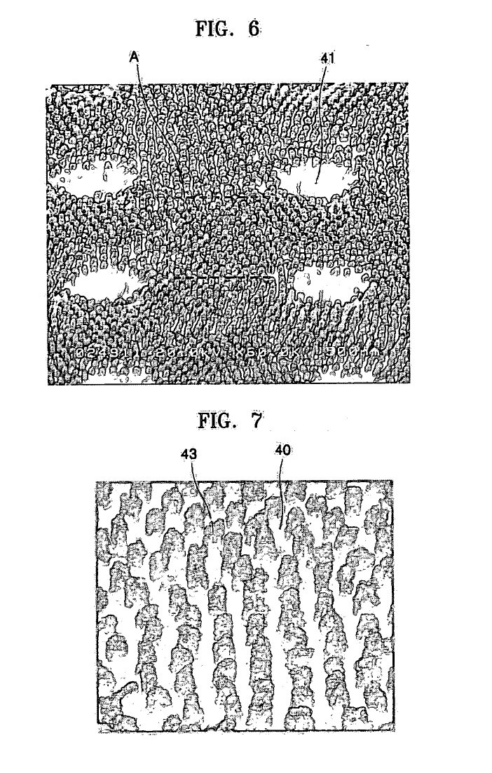

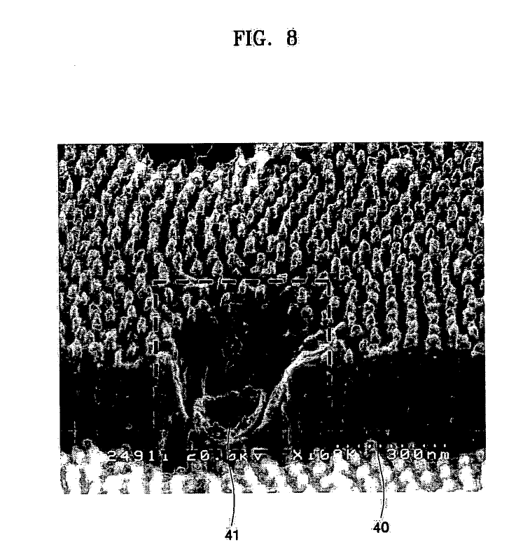

FIG. 6 is a view of carbon nanotubes obtained using a method of fabricating carbon nanotubes using an FIB according to an embodiment of the present invention. FIG. 7 is an enlarged view of a portion A illustrated in FIG. 6. FIG. 8 is a view of a portion of a pattern formed using an FIB.

Referring to FIGS. 6 through 8, a predetermined pattern 41 is formed on a substrate 40 using the FIB and the carbon nanotubes 43 are grown on the patterned substrate 40. Ga ions contained in the FIB function as growth nuclei for the carbon nanotubes 43 and the carbon nanotubes 43 may be grown a portion of the substrate 40 on which the pattern 41 is not formed. Thus, according to the present embodiment, due to the use of the FIB, the pattern 41 can be selectively formed at the nano-level on the substrate 40 and easily formed in various forms.

In a method of fabricating carbon nanotubes using an FIB according to the present invention, by scanning a substrate with the FIB, the carbon nanotubes may be selectively grown at the nano-level on a fine portion of the substrate and the pattern can be easily formed in various forms.

Due to the above effects, the method of fabricating the carbon nanotubes using the FIB can be used in the fabrication of transistor arrays in a semiconductor process and sensors, for example, gas sensors, chemical sensors, and biosensors.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of fabricating carbon nanotubes using a focused ion beam (FIB), comprising:
preparing a substrate;
scanning the substrate with the FIB; and
growing the carbon nanotubes on the scanned substrate.

2. The method of claim 1, wherein in the scanning the substrate with the FIB, ions contained in the FIB are implanted into a surface of the substrate.

3. The method of claim 2, wherein the FIB contains gallium (Ga) ions.

4. The method of claim 2, wherein in the growing the carbon nanotubes, the carbon nanotubes are grown on the implanted ions using a chemical vapor deposition (CVD) method.

5. The method of claim 4, wherein a hydrocarbon gas is used to grow the carbon nanotubes.

6. The method of claim 1, wherein the substrate is composed of at least one material selected from the group consisting of Si, SiO₂, Al₂O₃, GaN, GaAs, SiC, and SiN.

7. A method of fabricating carbon nanotubes using an FIB, comprising:
preparing a substrate;
patterning the substrate using the FIB;
scanning the patterned substrate with the FIB; and
growing the carbon nanotubes on the scanned substrate.

8. The method of claim 7, wherein in the scanning the substrate with the FIB, ions contained in the FIB are implanted into a surface of the substrate.

9. The method of claim 8, wherein the FIB contains Ga ions.

10. The method of claim 8, wherein in the growing the carbon nanotubes, the carbon nanotubes are grown on the implanted ions using a CVD method.

11. The method of claim 10, wherein a hydrocarbon gas is used to grow the carbon nanotubes.

12. The method of claim 7, wherein the substrate is composed of at least one material selected from the group consisting of Si, SiO₂, Al₂O₃, GaN, GaAs, SiC, and SiN.
